(19) United States
(12) Patent Application Publication
(10) Pub. No.: US 2009/0193815 A1
(43) Pub. Date: Aug. 6, 2009

(54) CRYOGENIC STORAGE DEVICE

(75) Inventors: HUNG-KUANG HSU, Chu-Nan (TW); CHUN-WEI WANG, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/233,814

(22) Filed: Sep. 19, 2008

(30) Foreign Application Priority Data
Jan. 31, 2008 (CN) 200810300287.4

(51) Int. Cl. F17C 3/02; F25D 23/02; F25B 39/02; F25D 27/00; F25D 17/06

(52) U.S. Cl. 62/45.1; 62/449; 62/515; 62/264; 62/426

(57) ABSTRACT

A cryogenic storage device includes a main body and a door. The main body defines an opening and a compartment. The door is rotatably connected to an edge of the opening. An evaporator is positioned in the compartment and configured to produce cold air. A fan is positioned in the compartment and configured to drive the cold air to flow in the compartment. An illumination component is positioned in the compartment and includes several of light emitting diodes. A door switch is positioned on an edge of the opening and configured to detect if the door is opened or closed to turn on and off the light emitting diodes.

### CROSS-REFERENCE STATEMENT

The present application is based on, and claims priority from, CN Application Serial Number 200810300287.4, filed on Jan. 31, 2008, titled cryogenic storage device, the disclosure of which is hereby incorporated by reference herein in its entirety.

### BACKGROUND

1. Technical Field

The disclosed embodiments generally relates to a cryogenic storage device which uses light emitting diodes as a light source for illumination.

2. Description of Related Art

Cryogenic storage devices, such as refrigerators, require light sources to illuminate items stored in a compartment of the cryogenic storage devices.

A typical cryogenic storage device uses a fluorescent lamp or an incandescent lamp as a light source. The fluorescent lamp and the incandescent lamp must be heated by a heater positioned in the cryogenic storage device prior to emitting light. However, the fluorescent lamp and the incandescent lamp cannot effectively emit light in a cryogenic environment, thus limiting the illumination effect in the cryogenic storage device.

Therefore, a new cryogenic storage device is desired to overcome the above-described shortcoming.

### SUMMARY

An embodiment of a cryogenic storage device includes a main body and a door. The main body defines an opening and a compartment. The door is rotatably connected to an edge of the opening. An evaporator is positioned in the compartment and configured to produce cold air. A fan is positioned in the compartment and configured to drive the cold air to flow in the compartment. An illumination component is positioned in the compartment and includes a plurality of light emitting diodes. A door switch is positioned on an edge of the opening and configured to detect if the door is open and closed to turn on and off the plurality of light emitting diodes.

Other advantages and novel features will become more apparent from the following detailed description when taken in conjunction with the accompanying drawings.

### BRIEF DESCRIPTION OF THE DRAWINGS

Many aspects of the cryogenic storage device can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cross-sectional view of one embodiment of a cryogenic storage device.

FIG. 2 is a cross-sectional view of another embodiment of a cryogenic storage device.

### DETAILED DESCRIPTION OF THE EMBODIMENTS

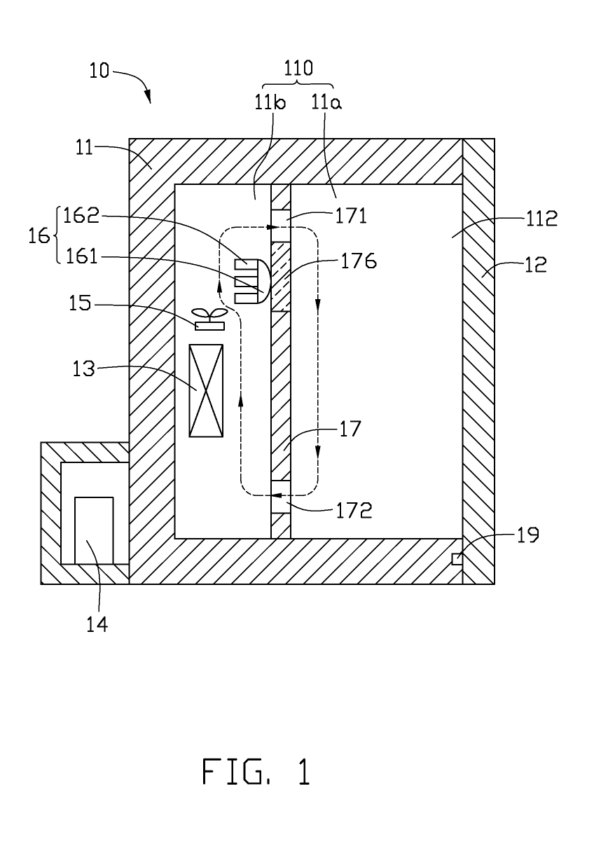

Referring to FIG. 1, one embodiment of a cryogenic storage device 10 includes a main body 11 defining an opening 112 and a compartment 110 therein, a door 12, and a compressor 14. The door 12 is rotatably connected to an edge of the opening 112 and configured to open and close the cryogenic storage device 10. The compressor 14 is positioned outside the main body 11 and configured to condense a refrigerant.

The main body 11 may be made of a thermal insulation material. The compartment 110 may be partitioned into a first compartment 11a and a second compartment 11b by an interlayer 17. The first compartment 11a may be used to store fresh food.

A first passage 171 and a second passage 172 are defined in the interlayer 17. A light transmission portion 176 to allow light to pass through is formed on the interlayer 17 adjacent to the first passage 171. The light transmission portion 176 may be a transparent portion or a through hole.

A fan 15 and an evaporator 13 are positioned in the second compartment 11b. The evaporator 13 is configured to produce cold air. The fan may be configured to drive cold air to circulate within the compartment 110. The fan 15 may be an axial-flow fan and may be positioned adjacent to the evaporator 13. The fan 15, the evaporator 13, and the compressor 14 cooperatively define a cooling system.

An illumination component 16 is positioned in the second compartment 11b adjacent to the fan 15. The illumination component 16 includes a plurality of light emitting diodes (LEDs) 161 and a heat dissipation member 162. The LEDs 161 are configured to emit light. Light emitted from the LEDs 161 passes through the light transmission portion 176 to illuminate the first compartment 11a. The heat dissipation member 162 is configured to dissipate heat emitted from the LEDs 161, such as a heat sink.

A door switch 19 is secured on an edge of the opening 112 and configured to detect if the door is opened to turn on the LEDs 161 and closed to turn off the LEDs 161. The door switch 19 may be an infrared sensor switch.

In use, the compressor 14 condenses a refrigerant. The evaporator 13 produces cold air when the condensed refrigerant evaporates. The fan 15 circulates cold air within the compartment 110 to generate a circulation path to cool items, such as food, stored in the first compartment 11a. When the door 12 is opened, the door switch 19 detects the opening of the door 12 and turns on the LEDs 161. When the door 12 is closed, the door switch 19 detects that the door is closed and turns off the LEDs 161.

In the embodiment of FIG. 1, when the door 12 is opened, the LEDs 161 can emit light without a heater. Thus, the cryogenic storage device 10 has a good illumination effect and a simple construction.

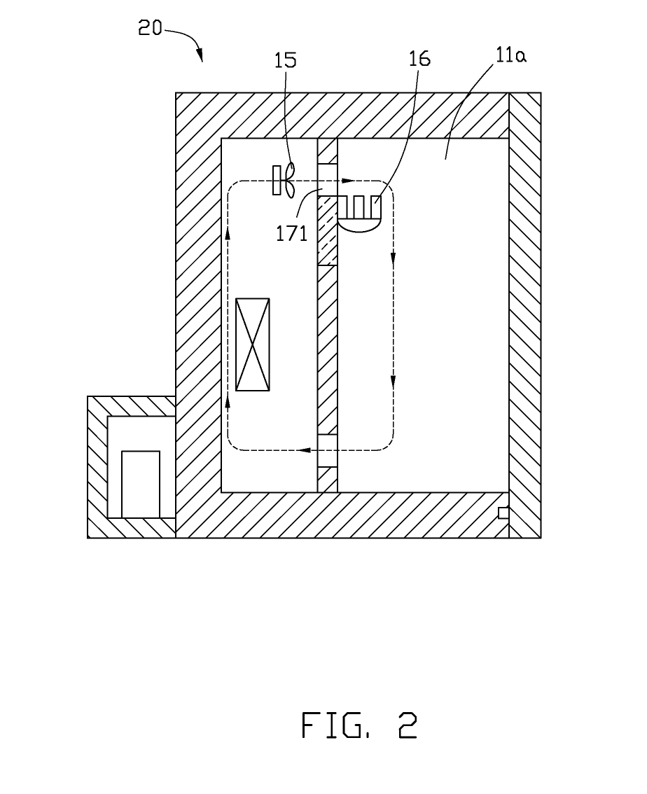

Referring to FIG. 2, another embodiment of a cryogenic storage device 20 is similar to the cryogenic storage device 10 of FIG. 1, except that the illumination component 16 is positioned in the first compartment 11a adjacent to the first passage 171, and the fan 15 is positioned adjacent to the first passage 171.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A cryogenic storage device comprising:
a main body defining an opening and a compartment;
a door rotatably connected to an edge of the opening;
an evaporator positioned in the compartment and configured to produce cold air;
a fan positioned in the compartment and configured to drive the cold air to flow in the compartment;
an illumination component positioned in the compartment, the illumination component comprising a plurality of light emitting diodes; and
a door switch positioned on an edge of the opening and configured to detect if the door is opened to turn on the plurality of light emitting diodes and closed to turn off the plurality of light emitting diodes.

2. The cryogenic storage device of claim 1, wherein the main body is made of a thermal insulation material.

3. The cryogenic storage device of claim 1, wherein the compartment is partitioned into a first compartment and a second compartment by an interlayer; a first passage and a second passage are defined in the interlayer; the evaporator and the fan are positioned in the second compartment, the first compartment is configured to store items.

4. The cryogenic storage device of claim 3, wherein the fan is positioned adjacent to the evaporator.

5. The cryogenic storage device of claim 3, wherein a light transmission portion is formed on the interlayer; the plurality of light emitting diodes are positioned in the second compartment adjacent to the light transmission portion.

6. The cryogenic storage device of claim 5, wherein the light transmission portion is selected from a group consisting of a transparent portion and a through hole.

7. The cryogenic storage device of claim 3, wherein the plurality of light emitting diodes are positioned in the first compartment adjacent to the first passage; the fan is positioned adjacent to the first passage.

8. The cryogenic storage device of claim 1, wherein the illumination component further comprises a heat dissipation member configured to dissipate heat emitted from the plurality of light emitting diodes.

9. The cryogenic storage device of claim 8, wherein the heat dissipation member is a heat sink.

10. The cryogenic storage device of claim 1, wherein the fan is an axial-flow fan.

11. The cryogenic storage device of claim 1, comprising a compressor positioned outside the main body.
